(19) United States
(12) Patent Application Publication
(10) Pub. No.: US 2026/0099553 A1
(43) Pub. Date: Apr. 9, 2026

(54) METHOD AND SYSTEM FOR PREDICTING RETRIEVAL FAILURE

(71) Applicants: SAMSUNG SDS CO., LTD., Seoul (KR); SEOUL NATIONAL UNIVERSITY R&DB FOUNDATION, Seoul (KR)

(72) Inventors: Gunhee KIM, Seoul (KR); Dayoon KO, Seoul (KR); Jin Hyuk KIM, Seoul (KR); Min Young LEE, Seoul (KR); Sung Hak SONG, Seoul (KR); Jae Hoon LEE, Seoul (KR); Jinyoung KIM, Seoul (KR)

(73) Assignees: SAMSUNG SDS CO., LTD., Seoul (KR); SEOUL NATIONAL UNIVERSITY R&DB FOUNDATION, Seoul (KR)

(21) Appl. No.: 19/349,611

(22) Filed: Oct. 3, 2025

(30) Foreign Application Priority Data
Oct. 7, 2024 (KR) 10-2024-0135761
Apr. 22, 2025 (KR) 10-2025-0052503

(51) Int. Cl. G06F 16/93; G06F 16/21

(52) U.S. Cl. CPC G06F 16/93; G06F 16/217

(57) ABSTRACT

Provided is a method for predicting retrieval failure, the method being performed by a computing system. The method may comprise: selecting one of a plurality of documents in a document corpus as a reference document; selecting one or more positive samples having high relevance to the reference document from among the plurality of documents in the document corpus, using a retrieval model; selecting one or more negative samples having low relevance to the reference document from among the plurality of documents in the document corpus, using the retrieval model; calculating a gradient norm of a contrastive loss using the reference document, a positive sample, and a negative sample; and comparing the gradient norm with a first reference value, and predicting whether the reference document is a retrieval failure-causing document, based on a comparing result.

### CROSS-REFERENCE TO RELATED APPLICATIONS

This application claims priority from Korean Patent Application No. 10-2024-0135761 filed on Oct. 7, 2024, and Korean Patent Application No. 10-2025-0052503 filed on Apr. 22, 2025, in the Korean Intellectual Property Office, and all the benefits accruing therefrom under 35 U.S.C. 119, the contents of which in its entirety are herein incorporated by reference.

### BACKGROUND

### Field

The present disclosure relates to a method and system for predicting a retrieval failure. More specifically, the present disclosure relates to a method and system for predicting, in advance, a document that may cause a retrieval failure in the future when a new document is added to an information retrieval system.

### Description of Related Art

An information retrieval system is a system that retrievals a document related to a user's query in large storage such as database. Such an information retrieval system generally performs retrieval based on a similarity between the document and the query, and is largely classified into a sparse retriever based on lexical similarity and a dense retriever based on vector embedding similarity according to an implementation scheme thereof.

In this regard, the dense retriever is implemented by pre-embedding a document to be retrieved and storing the document embedding in a retrieval index, and in response to input of a query, comparing the document embedding with an embedding of the query and retrieving a document with a high similarity to the query, based on the comparing result. However, in an actual operating environment, the retrieval target document is not maintained in a fixed state, and new documents are continuously introduced. In this way, the newly introduced document may have a distribution different from that of existing training data, and in this case, the existing retrieval model may not generate an appropriate embedding of the newly introduced document. Further, when a query related to the newly introduced document is input thereto thereafter, a retrieval failure may occur in which a correct document is not retrieved.

A scheme for solving this problem includes a scheme of generating a pseudo query from a new document using a language generation model and additionally training a retrieval model based on the query. However, this scheme not only takes a lot of resources and a high cost to generate additional training data, but also has a problem in that there is a limitation to improving model performance because the generated query may not match the actual user query.

Another scheme for solving the above problem includes a scheme in which a plurality of retrieval models specialized for various domains are modularized, and in response to a new document being introduced, a retrieval model suitable for the characteristics of the introduced document is selected and applied. However, this scheme continuously maintains and manages a retrieval model for each of the domains and selects a model or performs additional learning according to a new document type, thereby complicating a structure of the system and increasing the related management cost and the resources required for re-training.

Therefore, there is a need for a more efficient technology capable of evaluating in advance whether a newly introduced document is likely to cause a retrieval failure in the future and preventing performance degradation of a retrieval model.

### SUMMARY

A technical purpose to be achieved using some embodiments of the present disclosure is to provide a method and system for predicting, in advance, a document that may cause a retrieval failure based on a retrieval model.

Another technical purpose to be achieved using some embodiments of the present disclosure is to provide a method and system for identifying a retrieval failure-causing document among documents included in a new document corpus without generating additional data.

Still another technical purpose to be achieved using some embodiments of the present disclosure is to provide a method and system for determining a re-training time point of a retrieval model based on a ratio of a retrieval failure-causing document to a document corpus.

Still yet another technical purpose to be achieved using some embodiments of the present disclosure is to provide a method and system for selecting a retrieval model most suitable for a specific document corpus from among a plurality of retrieval models.

The technical purposes to be achieved by the present disclosure are not limited to the technical purposes as mentioned above, and other technical purposes not mentioned may be clearly understood by those skilled in the art related to the present disclosure based on the following detailed descriptions.

According to an aspect of the present disclosure, there is provided a method for predicting retrieval failure, the method being performed by a computing system. The method may comprise: selecting one document of a plurality of documents in a document corpus as a reference document; selecting one or more positive samples having high relevance to the reference document from among the plurality of documents in the document corpus, using a retrieval model; selecting one or more negative samples having low relevance to the reference document from among the plurality of documents in the document corpus, using the retrieval model; calculating a gradient norm of a contrastive loss using the reference document, a positive sample, and a negative sample; and comparing the gradient norm with a first reference value, and predicting whether the reference document is a retrieval failure-causing document, based on a comparing result.

In some embodiments, before selecting the one document as the reference document, the method may further comprise encoding each of the plurality of documents in the document corpus using the retrieval model to generate each embedding vector; and constructing database based on embedding vectors corresponding to the plurality of documents.

In some embodiments, the selecting of the positive sample may include: partially modifying the reference document to generate a modified reference document; and retrieving documents similar to the modified reference document from the document corpus, using the modified reference document as a retrieval query.

In some embodiments, the generating of the modified reference document may include: generating an embedding vector corresponding to the reference document; and applying probabilistic masking to the generated embedding vector to generate a modified embedding vector.

In some embodiments, the selecting of the negative sample may include: retrieving documents similar to each of the one or more positive samples from the document corpus, using each of the one or more positive samples as a retrieval query; and selecting a document other than the one or more positive samples among the retrieved documents as a hard negative sample.

In some embodiments, the predicting of whether the reference document is the retrieval failure-causing document may include: in response to that the gradient norm exceeds the first reference value, determining the reference document as the retrieval failure-causing document.

In some embodiments, the first reference value may be set using training data for training the retrieval model.

In some embodiments, the method may further comprise calculating a ratio of documents predicted as retrieval failure-causing documents in the document corpus; and determining whether to perform re-training of the retrieval model, based on whether the calculated ratio exceeds a second reference value.

According to the aforementioned and other embodiments of the present disclosure, there is provided a computing system comprising at least one processor; a memory configured to load a computer program to be executed by the at least one processor therein; and storage storing the computer program. The computer program may include instructions for: selecting one of a plurality of documents in a document corpus as a reference document; selecting one or more positive samples having high relevance to the reference document from among the plurality of documents in the document corpus, using a retrieval model; selecting one or more negative samples having low relevance to the reference document from among the plurality of documents in the document corpus, using the retrieval model; calculating a gradient norm of a contrastive loss using the reference document, a positive sample, and a negative sample; and comparing the gradient norm with a first reference value, and predicting whether the reference document is a retrieval failure-causing document, based on a comparing result.

In some embodiments, the computer program may further include instructions for: encoding each of the plurality of documents in the document corpus using the retrieval model to generate each embedding vector; and constructing database based on embedding vectors corresponding to the plurality of documents.

In some embodiments, the selecting of the positive sample may include: partially modifying the reference document to generate a modified reference document; and retrieving documents similar to the modified reference document from the document corpus, using the modified reference document as a retrieval query.

In some embodiments, the generating of the modified reference document may include: generating an embedding vector corresponding to the reference document; and applying probabilistic masking to the generated embedding vector to generate a modified embedding vector.

In some embodiments, the selecting of the negative sample may include: retrieving documents similar to each of the one or more positive samples from the document corpus, using each of the one or more positive samples as a retrieval query; and selecting a document other than the one or more positive samples among the retrieved documents as a hard negative sample.

In some embodiments, the predicting of whether the reference document is the retrieval failure-causing document may include: in response to that the gradient norm exceeds the first reference value, determining the reference document as the retrieval failure-causing document.

In some embodiments, the computer program may further include instructions for: calculating a ratio of documents predicted as retrieval failure-causing documents in the document corpus; and determining whether to perform re-training of the retrieval model, based on whether the calculated ratio exceeds a second reference value.

According to the aforementioned and other embodiments of the present disclosure, there is provided a non-transitory computer-readable medium storing a computer program, wherein, when executed by a computing system, the computer program may cause the computing system to: select one of a plurality of documents in a document corpus as a reference document; select one or more positive samples having high relevance to the reference document from among the plurality of documents in the document corpus, using a retrieval model; select one or more negative samples having low relevance to the reference document from among the plurality of documents in the document corpus, using the retrieval model; calculate a gradient norm of a contrastive loss using the reference document, a positive sample, and a negative sample; and compare the gradient norm with a first reference value, and predict whether the reference document is a retrieval failure-causing document, based on a comparing result.

### BRIEF DESCRIPTION OF DRAWINGS

The above and other aspects and features of the present disclosure will become more apparent by describing in detail various embodiments thereof with reference to the attached drawings, in which:

FIG. 1 is a diagram illustrating an example of a configuration of an entire system for performing a retrieval failure prediction method according to an embodiment of the present disclosure;

FIG. 2 is a diagram for illustrating a retrieval model that may be referred to in some embodiments of the present disclosure;

FIGS. 3 to 5 illustrate a process of predicting a retrieval failure-causing document according to an embodiment of the present disclosure;

FIG. 6 is a flowchart illustrating a retrieval failure prediction method according to another embodiment of the present disclosure;

FIG. 7 is a detailed flowchart of step S62 of FIG. 6;

FIG. 8 is a detailed flowchart of step S63 of FIG. 6;

FIG. 9 is a diagram for illustrating an example in which a retrieval failure prediction method according to an embodiment of the present disclosure is applied; and

FIG. 10 is a block diagram illustrating a hardware configuration of a computing system for performing a retrieval failure prediction method according to some embodiments of the present disclosure.

### DETAILED DESCRIPTIONS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

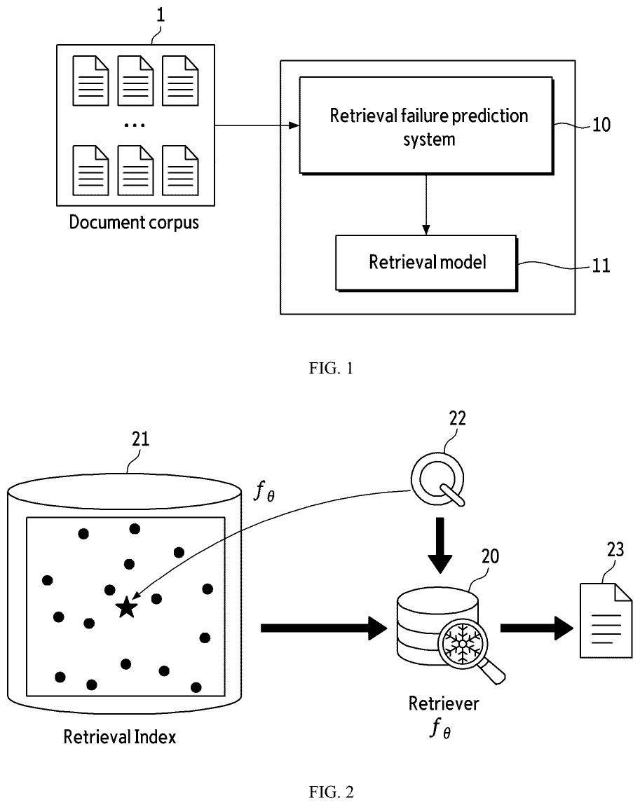

FIG. 1 is a diagram illustrating an example of a configuration of an entire system for performing a retrieval failure prediction method according to an embodiment of the present disclosure.

As illustrated in FIG. 1, the entire system for performing the retrieval failure prediction method according to an embodiment of the present disclosure may include a retrieval failure prediction system 10 and a retrieval model 11.

According to an embodiment of the present disclosure, the retrieval failure prediction system 10 may predict, in advance, a retrieval failure that may occur when a new document corpus 1 is introduced, based on the retrieval model 11. In this regard, the retrieval failure refers to a situation in which when the new document has a distribution different from that of the existing training data, the retrieval model 11 may not accurately encode or retrieve the new document. In an embodiment, the document corpus 1 refers to a set of new documents to be added to a retrieval index (i.e., embedding-based database) of the retrieval model 11, and may include documents having a distribution different from that of existing training data.

According to an embodiment of the present disclosure, the retrieval model 11 may be a dense retriever. The dense retriever refers to a model that maps the query and the document to a high-dimensional embedding space using a deep learning-based embedding model, and retrieves a related document based on vector similarity therebetween. In some cases, the retrieval model 11 may be referred to as a ‘retriever’, a ‘dense retriever’, an ‘embedding model’, or an ‘information retrieval model’.

Hereinafter, a manner in which the retrieval model 11 operates will be described in detail with reference to FIG. 2.

FIG. 2 is a diagram for illustrating a retrieval model that may be referred to in some embodiments of the present disclosure.

As shown in FIG. 2, the retrieval model 20 may be implemented as a dense retriever, which may be a deep learning-based model trained so as to allow a similarity between documents related to a query to be higher and allow a similarity between documents unrelated thereto to be lower.

The documents to be retrieved are converted into embedding vectors by a document encoder of the retrieval model 20, and these embeddings are stored in a retrieval index 21 in a form of vector indexes. Thereafter, when a query 22 is input, the query 22 is also converted into an embedding vector using a query encoder of the same retrieval model 20. The retrieval model 20 calculates a similarity between the embedding vector corresponding to the query 22 and the embedding vector corresponding to each of the documents stored in the retrieval index 21, selects a document having a high similarity, and returns the selected document as a retrieval result document 23.

When a new document corpus is introduced and a document therein is added to the retrieval index without separate verification, there is a possibility that the existing retrieval model may not properly retrieve the added document. That is, when a document having a distribution different from that of the existing training data is included in the corpus, the retrieval model may not generalize the document, and thus the retrieval performance may be degraded.

Accordingly, when a new document is added to the retrieval index (i.e., the embedding-based database), the retrieval failure prediction system 10 according to the present embodiment may predict in advance whether the new document is likely to cause a retrieval failure based on a query in the future. In an embodiment, the retrieval failure prediction system 10 may identify a retrieval failure-causing document included in the document corpus 1. In this regard, the retrieval failure-causing document refers to a document which the retrieval model 11 may not or cannot accurately encode or retrieve, and refers to a document which is not retrieved based on a related query or which may be retrieved as an incorrect document based on the related query in the future.

In an embodiment, the retrieval failure prediction system 10 may predict the retrieval failure-causing document using a gradient norm calculated from a loss function of contrastive learning. In this regard, the gradient norm refers to an index that measures an amount of change in a model parameter with respect to the loss function, that is, a magnitude of the gradient, and indicates how sensitive the model is to given data. In general, the larger the gradient norm, the less the model understands or generalizes the data.

Specifically, the retrieval failure prediction system 10 may set one of a plurality of documents in the document corpus 1 as a reference document, and select a positive sample and a negative sample based on the reference document. In addition, whether the reference document may be the retrieval failure-causing document may be predicted by calculating a gradient norm of a contrastive loss using the reference document, the positive sample, and the negative sample, and comparing the calculated gradient norm with a reference value.

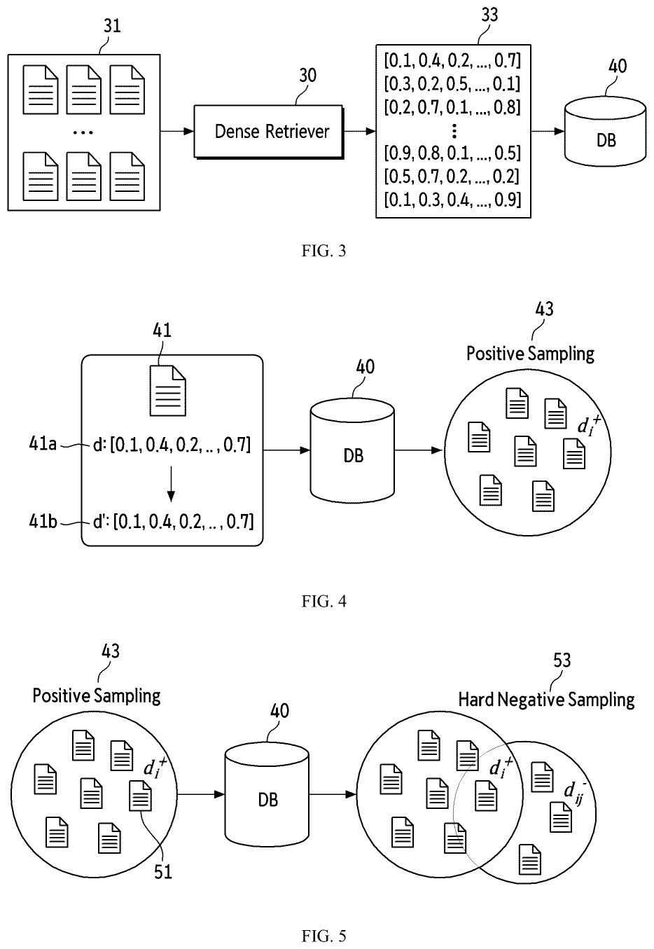

Hereinafter, a process in which the retrieval failure prediction system 10 predicts a retrieval failure-causing document will be described in more detail with reference to FIGS. 3 to 5.

FIGS. 3 to 5 illustrate a process of predicting a retrieval failure-causing document according to an embodiment of the present disclosure. It should be noted that the dense retriever in FIGS. 3 to 5 corresponds to the retrieval model 11 as described in FIG. 1.

First, FIG. 3 shows an example of a process of constructing vector-based database based on a document corpus. As shown in FIG. 3, a new document corpus 31 composed of a plurality of documents is input to a dense retriever 30. The dense retriever 30 converts each document into an embedding vector 33 and constructs database 40 using these vectors. The database 40 constructed in this way allows the dense retriever 30 to quickly retrieve a document similar to the input query.

Next, a process of selecting a positive sample will be described with reference to FIG. 4.

First, one document among a plurality of documents in the document corpus is set as a reference document 41, and a document similar to the reference document 41 is retrieved from the database 40 constructed in FIG. 3 to perform positive sampling. In this regard, the reference document 41 becomes a target document subject to the retrieval failure prediction. That is, whether the retrieval failure of the reference document 41 may occur may be evaluated.

In this case, in order to more precisely evaluate encoding performance at which the retrieval model encodes the reference document 41, a similar document may be retrieved in the document corpus using a modified reference document obtained by applying a partial modification to the reference document 41 as a retrieval query. When the retrieval model has sufficient generalization performance of the reference document 41, a similar document may be stably retrieved from the document corpus even when the partial modification is applied to the reference document 41. However, when the retrieval model may not generalize the reference document 41, a similar document may not be accurately retrieved in a retrieval process based on the modified reference document, and thus, the encoding performance at which the retrieval model encodes the reference document 41 may be more precisely evaluated.

Specifically, after encoding the reference document 41 to generate an embedding vector 41a corresponding to the reference document, a modified embedding vector 41b may be generated by applying probabilistic masking to the embedding vector 41a. The modified embedding vector 41b may be used as the retrieval query to retrieve k documents having higher similarity from the database 40, and some or all of the retrieved documents may be selected as positive samples 43. In this regard, the probabilistic masking may be applied based on a mask following a Bernoulli distribution.

Next, a process of selecting a negative sample will be described with reference to FIG. 5.

First, one positive sample 51 among the plurality of positive samples 43 selected in the positive sampling process performed in FIG. 4 is selected as a retrieval query, and then documents similar to the selected positive sample 51 are retrieved from the database 40. Thereafter, documents other than the positive samples selected in the positive sampling process among the retrieved documents are selected as a hard negative sample 53. This process is repeatedly performed on each of the plurality of positive samples to select a plurality of hard negative samples corresponding to the reference document. In this regard, the selected hard negative sample is a document similar to the positive sample but having low relevance to the reference document. Thus, how well the retrieval model identifies a minute semantic difference between documents may be evaluated.

When the positive sample and the negative sample have been selected through the above-described process, the retrieval failure prediction system 10 may calculate a gradient norm for the reference document and evaluate the retrieval failure possibility of the reference document based on this calculation result. Hereinafter, a process of calculating a gradient norm will be described using a specific Equation. In one example, the reference document used in the following Equation may be a modified reference document. That is, the modified reference document may be applied as an item expressed as the reference document in the Equation.

First, the retrieval failure prediction system 10 calculates the contrastive loss. In this regard, the similarity between documents is defined as in Equation 1, and the contrastive loss may be calculated as in Equation 2 based on the similarity function.

$$s ( q , d ) = cos ( {E}_{Q} ( q ) , {E}_{D} ( d ) ) \qquad [ Equation 1 ]$$

where q is a reference document (or document query), d is a sampling document, E_{Q}(q) is an embedding vector of the reference document q, E_{D}(d) is an embedding vector of the sampling document d, and cos is a cosine similarity function.

$${ℒ}_{InfoNCE} = - log \frac{{e}^{s ( q , {d}^{+} ) / τ}}{{e}^{s ( q , {d}^{+} ) / τ} + {\sum }_{i = 1}^{N} {e}^{s ( q , {d}_{i}^{-} ) / τ}} \qquad [ Equation 2 ]$$

where d⁺ is a positive sample document, dᵢ⁻ is a negative sample document, and τ is a temperature parameter. In this regard, the contrastive loss is adapted to maximize the similarity between the reference document (or the modified reference document) and the positive sample, and at the same time, minimize the similarity between the reference document (or the modified reference document) and the negative sample.

Next, a gradient vector with respect to a parameter θ on the contrastive loss function defined based on the reference document, the positive sample, and the negative sample is calculated as in Equation 3. Thereafter, as shown in Equation 4 as set forth below, an average of the gradient norms as calculated on all positive samples selected for the reference document is calculated.

$$∇ {ℒ}_{θ} = - {∇}_{θ} log \frac{{e}^{s ( d , {d}^{+} ) / τ}}{{e}^{s ( d , {d}^{+} ) / τ} + {\sum }_{i = 1}^{p} {e}^{s ( d , {d}_{i}^{-} ) / τ}} \qquad [ Equation 3 ]$$

$$gradnorm = \frac{i}{p} {\sum }_{i = 1}^{p} {‖ {∇}_{θ} ℒ ‖}_{p} , \qquad [ Equation 4 ]$$

where p denotes the number of positive samples per reference document, and ∥·∥ₚ denotes a L-p norm.

The average gradient norm calculated as described above may be used as an indicator quantitatively indicating the possibility that the reference document is not properly processed by the retrieval model. Specifically, the retrieval failure prediction system 10 may compare the calculated gradient norm with a reference value (hereinafter, referred to as a first reference value) and determine whether the reference document may be a retrieval failure-causing document based on the comparing result. For example, when the gradient norm exceeds the first reference value, the reference document may be determined as the retrieval failure-causing document. In this regard, the first reference value may be set using the existing training data of the retrieval model. More specifically, a plurality of documents randomly selected from the training data are set as reference documents, positive samples and negative samples are selected for each of the reference documents, and then the gradient norm is calculated based on the contrastive loss. The average value of the plurality of gradient norms calculated in this way may be set as the first reference value.

Referring back to FIG. 1, in an embodiment, the retrieval failure prediction system 10 may determine a re-training time point of the retrieval model 11. Specifically, the retrieval failure prediction system 10 may calculate a ratio of the retrieval failure-causing documents included in the document corpus 1. When the calculated ratio exceeds a preset reference value, it may be determined that re-training of the retrieval model 11 is necessary.

In the above descriptions, the configuration and the operation of the entire system for performing the retrieval failure prediction method according to embodiments of the present disclosure have been described above in detail with reference to FIGS. 1 to 5. The embodiments described above may be understood in more detail with reference to other embodiments to be described later. In addition, the technical idea that may be understood from the above-described embodiments may be applied to other embodiments to be described later, unless otherwise specified.

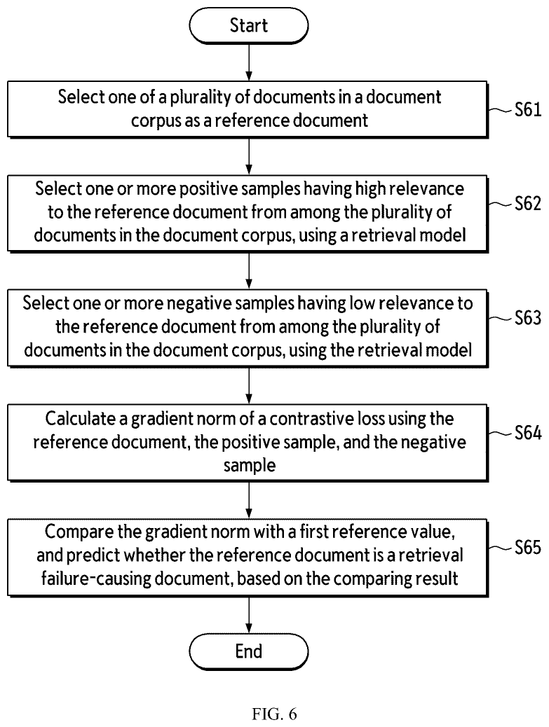

Hereinafter, a retrieval failure prediction method according to another embodiment of the present disclosure will be described with reference to the drawings of FIG. 6. It may be understood that steps in some flowcharts to be described below are performed by the retrieval failure prediction system 10 (hereinafter, referred to as a “system”) described with reference to FIG. 1 unless otherwise stated. However, a subject of performing a specific step/operation may vary depending on the implementation scheme.

FIG. 6 is a flowchart illustrating a retrieval failure prediction method according to another embodiment of the present disclosure. However, this is only a preferred embodiment for achieving the purpose of the present disclosure, and it is obvious that some steps may be added or deleted as necessary. In addition, for convenience of description, the description of the subject of performing each step may be omitted.

As illustrated in FIG. 6, in step S61, one document among a plurality of documents in a document corpus may be selected as a reference document. In this regard, the document corpus refers to a set of new documents to be added to the retrieval index of the retrieval model, that is, the embedding-based database, and may be a target document set on which the possibility of retrieval failure is evaluated.

In one example, prior to step S61, an operation for building database based on the document corpus may be executed. More specifically, each of a plurality of documents in the document corpus may be encoded using the retrieval model, and an embedding vector corresponding to each document may be generated. Based on these embedding vectors, the embedding-based database (or the retrieval index) may be constructed.

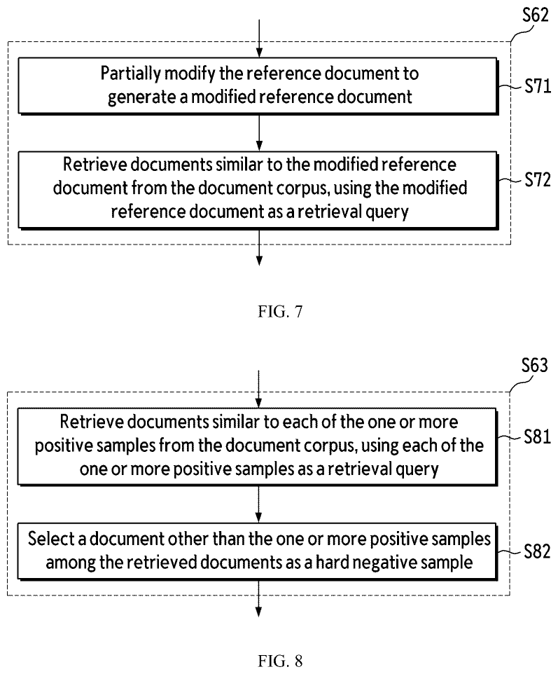

Next, in step S62, one or more positive samples having high relevance to the reference document may be selected from among the plurality of documents in the document corpus using the retrieval model. This will be described in detail with reference to FIG. 7.

FIG. 7 is a detailed flowchart of step S62 of FIG. 6.

First, in step S71, a modified reference document may be generated by applying a partial modification to the reference document. Specifically, an embedding vector corresponding to the reference document may be generated by inputting the reference document into the retrieval model. Then, a modified embedding vector may be generated by applying probabilistic masking to the generated embedding vector.

Next, in step S72, documents similar to the modified reference document may be retrieved from the document corpus using the modified reference document as the retrieval query. More specifically, the similarity between the modified embedding vector and the embedding vector corresponding to each of the documents in the document corpus may be calculated using the retrieval model, and documents having the higher similarity may be derived based on the calculated similarity. In this regard, one or more of the retrieved documents may be selected as a positive sample for the reference document.

Referring back to FIG. 6, in step S63, one or more negative samples having low relevance to the reference document among the plurality of documents in the document corpus may be selected using the retrieval model. This will be described with reference to FIG. 8.

FIG. 8 is a detailed flowchart of step S63 of FIG. 6.

Referring to FIG. 8, documents similar to each of the one or more positive samples may be retrieved from the document corpus using each of the one or more positive samples as a retrieval query in step S81. Specifically, the retrieval model may encode each positive sample as an input query to generate an embedding vector and calculate a similarity between the generated embedding vector and an embedding vector of each of the documents of the document corpus, and may derive documents having a higher similarity based on the calculated similarity.

Next, in step S82, documents except for one or more positive samples selected in the previous step among the retrieved documents may be selected as hard negative samples. In this regard, the hard negative sample refers to a document that has a high similarity to the positive sample, but has low relevance to the reference document.

Referring back to FIG. 6, in step S64, a gradient norm of a contrastive loss may be calculated using the reference document, and the positive sample and the negative sample selected based on the reference document. The gradient norm is an indicator of a magnitude of a gradient of a loss function with respect to a parameter of a retrieval model, and may indicate how sensitive the retrieval model is to the document. A more detailed description related to the calculation of the gradient norm will be referred to the description in the previous embodiment.

Next, in step S65, the gradient norm may be compared with a preset reference value (first reference value). Based on the comparing result, it may be predicted whether the reference document may be the retrieval failure-causing document. Specifically, when the gradient norm exceeds the first reference value, the reference document may be determined as the retrieval failure-causing document. In this regard, the first reference value may be set based on the existing training data of the retrieval model, for example, a document set which has been used for pre-training the retrieval model. Specifically, after setting the reference document from among a plurality of documents randomly selected from the training data, a positive sample and a negative sample are selected for the reference document, and a gradient norm is calculated based on the contrastive loss. The average value of the plurality of gradient norms calculated in this way may be set as the first reference value.

The retrieval failure prediction method according to another embodiment of the present disclosure has been described in detail with reference to FIGS. 6 to 8. As described above, the retrieval failure-causing document included in the new document corpus may be predicted in advance based on the retrieval model. In addition, using the document itself as the retrieval query may allow the performance of the retrieval model to be evaluated using only a given document corpus without generating additional training data or performing query generation. In addition, using the modified reference document and the hard negative sample may allow the generalization performance of the retrieval model to be more precisely diagnosed.

The above-described method may be repeatedly performed on each of the plurality of documents in the document corpus, and thus, the possibility of retrieval failure of the entire document corpus may be comprehensively evaluated. Accordingly, it may be determined whether to perform re-training of the retrieval model based on the document corpus. More specifically, the ratio of the retrieval failure-causing documents included in the document corpus may be calculated. When the calculated ratio exceeds a preset reference value (second reference value), it may be determined that re-training of the retrieval model is necessary. In this regard, the second reference value may be flexibly set according to a system operation purpose, a domain characteristic, a user request, etc. For example, a conservative re-training condition may be applied by setting the second reference value to be relatively lower in domains such as laws, medical care, and technology patents requiring high retrieval accuracy. On the other hand, in an environment in which the use efficiency of system resources is more important, the second reference value may be set to be higher to more flexibly determine whether to re-train the retrieval model.

The determination result may be provided in a form of being guided to the user through a user terminal (not shown). In some cases, the system may be configured to automatically perform a re-training procedure. Accordingly, when the ratio of the retrieval failure-causing documents is lower than or equal to the second reference value, unnecessary re-training is omitted, thereby effectively reducing system resources and time cost.

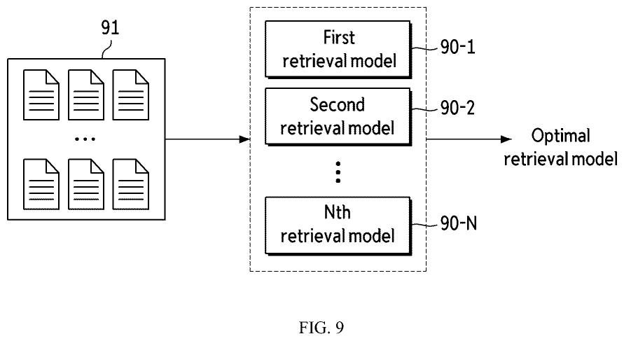

The retrieval failure prediction method according to an embodiment of the present disclosure may be usefully utilized not only for determining whether to re-train the retrieval model, but also for selecting a retrieval model suitable for a specific document corpus in advance. This will be described with reference to FIG. 9 below.

FIG. 9 is a diagram for illustrating an example in which a retrieval failure prediction method according to an embodiment of the present disclosure is applied.

As illustrated in FIG. 9, when a specific document corpus 91 is given, a retrieval failure prediction procedure may be performed on each of a plurality of retrieval models 90-1, 90-2, . . . , 90-N. That is, a retrieval failure-causing document in the documents in the document corpus 91 may be predicted based on each retrieval model according to the above-described method, and a ratio of the retrieval failure-causing documents predicted based on each retrieval model may be calculated.

Thereafter, the ratios of the retrieval failure-causing documents based on the retrieval models may be compared with each other. A retrieval model most suitable for the document corpus 91 may be selected based on the comparing result. In other words, it may be determined that the retrieval model having the lowest ratio of the retrieval failure-causing documents has high generalization performance with respect to the document corpus 91, and an optimal retrieval model may be selected based thereon.

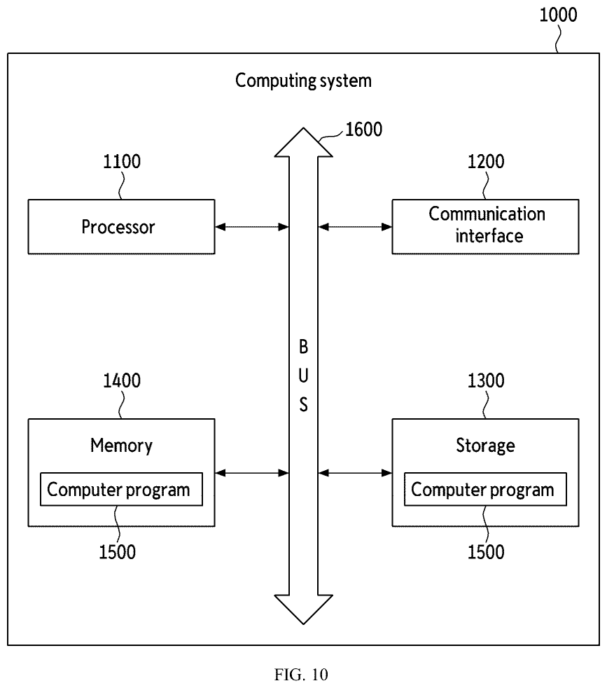

Hereinafter, an example computing system 1000 in which the retrieval failure prediction method as described above may be implemented will be described with reference to FIG. 10.

FIG. 10 is a block diagram illustrating a hardware configuration of a computing system for performing a retrieval failure prediction method according to some embodiments of the present disclosure.

Referring to FIG. 10, a computing system 1000 may include one or more processors 1100, a system bus 1600, a communication interface 1200, a memory 1400 for loading a computer program 1500 executed by the processor 1100 thereon, and a storage 1300 for storing the computer program 1500 therein. However, in FIG. 10, only components related to an embodiment of the present disclosure are illustrated. Accordingly, those skilled in the art to which the present disclosure pertains may appreciate that the computing system may further include general-purpose components other than the components shown in FIG. 10. That is, the computing system 1000 may further include various components in addition to the components illustrated in FIG. 10. In addition, in some cases, the computing system 1000 may be configured in a form in which some of the components illustrated in FIG. 10 are omitted. Hereinafter, each component of the computing system 1000 will be described.

The processor 1100 may control an overall operation of each of the components of the computing system 1000. The processor 1100 may include at least one of a central processing unit (CPU), a micro-processor unit (MPU), a micro-controller unit (MCU), a graphic processing unit (GPU), or any type of processor well known in the technical field of the present disclosure. In addition, the processor 1100 may perform an operation on at least one application or program for executing specific steps/operations/methods. The processor 1100 may include one or more processors.

Next, the memory 1400 may store various data, commands, and/or information therein. The memory 1400 may load thereon the computer program 1500 from the storage 1300 to execute an operation/method according to embodiments of the present disclosure. The memory 1400 may be implemented as a volatile memory such as RAM. However, the technical scope of the present disclosure is not limited thereto.

Next, the bus 1600 may provide a communication function between the components of the computing system 1000. The bus 1600 may be implemented as various types of buses such as an address bus, a data bus, and a control bus.

Next, the communication interface 1200 may support wired/wireless Internet communication of the computing system 1000. In addition, the communication interface 1200 may support various communication schemes other than Internet communication. To this end, the communication interface 1200 may be configured to include a communication module well known in the technical field of the present disclosure.

Next, the storage 1300 may non-temporarily store one or more computer programs 1500 therein. The storage 1300 may include a non-volatile memory such as a read only memory (ROM), an erasable programmable ROM (EPROM), an electrically erasable programmable ROM (EEPROM), a flash memory, a hard disk, a removable disk, or any type of computer-readable recording medium well known in the art to which the present disclosure pertains.

The computer program 1500 may include one or more instructions. When the instructions are loaded into the memory 1400, the instructions cause the processor 1100 to perform specific steps/operations/methods. That is, the processor 1100 may perform specific steps/operations/methods by executing one or more instructions.

For example, the computer program 1500 may include instructions for selecting one of a plurality of documents in a document corpus as a reference document; selecting one or more positive samples having high relevance to the reference document from among the plurality of documents in the document corpus, using a retrieval model; selecting one or more negative samples having low relevance to the reference document from among the plurality of documents in the document corpus, using the retrieval model; calculating a gradient norm of a contrastive loss using the reference document, the positive sample, and the negative sample; and comparing the gradient norm with a first reference value, and predicting whether the reference document is a retrieval failure-causing document, based on the comparing result.

In one example, in some embodiments, the computing system 1000 illustrated in FIG. 10 may mean a virtual machine implemented based on cloud technology. For example, the computing system 1000 may be a virtual machine operating in one or more physical servers included in a server farm. In this case, at least some of the processor 1100, the memory 1400, and the storage 1300 among the components illustrated in FIG. 10 may be virtual hardware, and the communication interface 1200 may also be implemented as a virtualized networking element such as a virtual switch.

So far, a variety of embodiments of the present disclosure and the effects according to embodiments thereof have been mentioned with reference to FIGS. 1 to 10. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for predicting retrieval failure, the method being performed by a computing system, the method comprising:
selecting one document of a plurality of documents in a document corpus as a reference document;
selecting one or more positive samples having high relevance to the reference document from among the plurality of documents in the document corpus, using a retrieval model;
selecting one or more negative samples having low relevance to the reference document from among the plurality of documents in the document corpus, using the retrieval model;
calculating a gradient norm of a contrastive loss using the reference document, a positive sample, and a negative sample; and
comparing the gradient norm with a first reference value, and predicting whether the reference document is a retrieval failure-causing document, based on a comparing result.

2. The method of claim 1, further comprising, before selecting the one document as the reference document,
encoding each of the plurality of documents in the document corpus using the retrieval model to generate each embedding vector; and
constructing database based on embedding vectors corresponding to the plurality of documents.

3. The method of claim 1, wherein the selecting of the positive sample includes:
partially modifying the reference document to generate a modified reference document; and
retrieving documents similar to the modified reference document from the document corpus, using the modified reference document as a retrieval query.

4. The method of claim 3, wherein the generating of the modified reference document includes:
generating an embedding vector corresponding to the reference document; and
applying probabilistic masking to the generated embedding vector to generate a modified embedding vector.

5. The method of claim 1, wherein the selecting of the negative sample includes:
retrieving documents similar to each of the one or more positive samples from the document corpus, using each of the one or more positive samples as a retrieval query; and
selecting a document other than the one or more positive samples among the retrieved documents as a hard negative sample.

6. The method of claim 1, wherein the predicting of whether the reference document is the retrieval failure-causing document includes:
in response to that the gradient norm exceeds the first reference value, determining the reference document as the retrieval failure-causing document.

7. The method of claim 6, wherein the first reference value is set using training data for training the retrieval model.

8. The method of claim 1, further comprising:
calculating a ratio of documents predicted as retrieval failure-causing documents in the document corpus; and
determining whether to perform re-training of the retrieval model, based on whether the calculated ratio exceeds a second reference value.

9. A computing system comprising:
at least one processor;
a memory configured to load a computer program to be executed by the at least one processor therein; and
storage storing the computer program therein,
wherein the computer program includes instructions for:
selecting one of a plurality of documents in a document corpus as a reference document;
selecting one or more positive samples having high relevance to the reference document from among the plurality of documents in the document corpus, using a retrieval model;
selecting one or more negative samples having low relevance to the reference document from among the plurality of documents in the document corpus, using the retrieval model;
calculating a gradient norm of a contrastive loss using the reference document, a positive sample, and a negative sample; and
comparing the gradient norm with a first reference value, and predicting whether the reference document is a retrieval failure-causing document, based on a comparing result.

10. The computing system of claim 9, wherein the computer program further includes instructions for:
encoding each of the plurality of documents in the document corpus using the retrieval model to generate each embedding vector; and
constructing database based on embedding vectors corresponding to the plurality of documents.

11. The computing system of claim 10, wherein the selecting of the positive sample includes:
partially modifying the reference document to generate a modified reference document; and
retrieving documents similar to the modified reference document from the document corpus, using the modified reference document as a retrieval query.

12. The computing system of claim 11, wherein the generating of the modified reference document includes:
generating an embedding vector corresponding to the reference document; and
applying probabilistic masking to the generated embedding vector to generate a modified embedding vector.

13. The computing system of claim 9, wherein the selecting of the negative sample includes:
retrieving documents similar to each of the one or more positive samples from the document corpus, using each of the one or more positive samples as a retrieval query; and
selecting a document other than the one or more positive samples among the retrieved documents as a hard negative sample.

14. The computing system of claim 9, wherein the predicting of whether the reference document is the retrieval failure-causing document includes:
in response to that the gradient norm exceeds the first reference value, determining the reference document as the retrieval failure-causing document.

15. The computing system of claim 9, wherein the computer program further includes instructions for:
calculating a ratio of documents predicted as retrieval failure-causing documents in the document corpus; and
determining whether to perform re-training of the retrieval model, based on whether the calculated ratio exceeds a second reference value.

16. A non-transitory computer-readable medium storing a computer program, wherein when the computer program is executed by a computing system, the computer program causes the computing system to:
select one of a plurality of documents in a document corpus as a reference document;
select one or more positive samples having high relevance to the reference document from among the plurality of documents in the document corpus, using a retrieval model;
select one or more negative samples having low relevance to the reference document from among the plurality of documents in the document corpus, using the retrieval model;
calculate a gradient norm of a contrastive loss using the reference document, a positive sample, and a negative sample; and
compare the gradient norm with a first reference value, and predict whether the reference document is a retrieval failure-causing document, based on a comparing result.
